(19) United States
(12) Patent Application Publication
(10) Pub. No.: US 2010/0287244 A1
(43) Pub. Date: Nov. 11, 2010

(54) Data communication using disposable contact information

(75) Inventors: Richard Wicks, Sunnyvale, CA (US); Hirak Mitra, Sunnyvale, CA (US); Michael Moon, Sunnyvale, CA (US)

Correspondence Address: TUE NGUYEN, 496 OLIVE AVE, FREMONT, CA, 94539, US

(73) Assignee: NAVOSHA CORPORATION, Sunnyvale, CA (US)

(21) Appl. No.: 12/464,050

(22) Filed: May 11, 2009

(51) Int. Cl. G06F 15/16

(52) U.S. Cl. 709/206

(57) ABSTRACT

Methods and apparatuses for establishing a trusted group of users to prevent undesirable communication by employing authenticated contact information. In an embodiment, the present invention embeds authenticated contact information to data communication composed by members of the trusted group. Authenticated contact information is preferably disposable contact information, changeable as desired, at a regular interval, or one-time contact information. In another embodiment, the present invention discloses a process of expanding an existing trusted group of users to an outsider, comprising embedding authenticated contact information of a member within the trusted group to a data communication composed by the outsider to a member of the trusted group.

The present invention relates data communication and data processing system, and particularly to electronic message using disposable contact information.

### BACKGROUND

The Internet is a popular medium for data communication, such as sending electronic mail messages between different users. Emails have been replacing traditional letters and office correspondences in many cases, where the only requirement is the email address of the intended recipient. Email is much more convenient and cheaper than other forms of communication such as traditional mail. However, the low cost and ease of use of emails have lead to the severe problem of undesired communication. Automated processes have sent unsolicited emails indiscriminately to everybody. These unsolicited automated emails are typically unwanted by the recipients and are known as spam. Other forms of electronic communication are similarly affected, such as voicemail messages, short message service (SMS) messages, multi-media messaging service (MMS) messages, facsimile messages, etc. The term “emessage” as used herein is to be interpreted broadly to include any type of electronic message.

To remove unsolicited emessages, software, such as spam filter, can be configured to trap such emessages based on a variety of criteria, including the sender's emessage address (e.g. email address, phone number) with white list and black list, specific words in the subject or message body or by the type of attachment that accompanies the message. More sophisticated spam filters use complicated filtering rules, such as thousands of active rules together with artificial intelligence techniques, to analyze the content to be more effective in filtering spam. Therefore, rule-based filtering systems can be fairly expensive. Also, there are many false positive and false negative results reported by existing spam identification rules.

Currently, permanent addressing is used, such as an email address, phone number, an instant message ID, etc, to communicate with a particular individual or organization. Once this address is compromised by organizations that abuse it such as email marketers, IM marketers, etc.; currently, it is nearly impossible to block them because some senders forge their headers making it impossible to identify the true sender of the unwanted data. Often the recipient is overwhelmed by useless and unwanted data being sent to them, rendering the address useless, since only a small amount (if any) of the data received is desired. The problems caused by spam have lead to reluctance on the part of users to disclose their emessage addresses (email address, phone number, etc.). Email aliasing, temporary email addresses, multiple email addresses, and a new email address are a few methods to protect the primary or actual email address. These simple addressing schemes solve a few problems for a short period of time, but they create larger problems of manageability and usability.

### SUMMARY OF THE DESCRIPTION

The present invention relates to authenticated data communication between various parties, for example through Internet or telephone. The present invention can be applied to emails, instant messengers, point-to-point communication, and any communication process utilizing software to transfer through any data network.

In an embodiment, the present invention discloses methods and apparatuses for establishing a trusted group of users so that the communication between the members of the trusted group can be automatically considered as desired interchanges. The present trusted communication group can serve to eliminate unsolicited and undesired communication, such as advertisement or spam from marketers, without complicated or heuristic rules of spam filtering. In an aspect, the present invention selects (e.g., blocks and allows) data communication by using disposable contact information in conjunction with non-disposable contact information, together with sharing such disposable contact information safely.

In an aspect, the present invention embeds authenticated contact information data communication composed by members of the trusted group. Authenticated contact information can serve to establish that the data communication having authenticated contact information is generally considered to be desirable and trusted between members of the group. Authenticated contact information is disposable contact information, changeable as desired, at a regular interval, or one time contact information. In an aspect, authenticated contact information may be unique for each member of the group, normally used in conjunction with the member's permanent (or non-disposable) identification information such as the email address, phone number, or instant messenger ID. Authenticated contact information can be unique for each pair of members of the group, establishing trusted communication between these two members.

Authenticated contact information can be encrypted or not encrypted. Authenticated contact information can be chosen by the member, or automatically generated using a key and an algorithm. To improve security against breaching, one time authenticated contact information can be used, for example, new authenticated contact information or information to generate new authenticated contact information can be included in each communication for future communication. Thus, new authenticated contact information can be generated each time a communication is sent or received.

In an embodiment, the present invention discloses a process of expanding an existing trusted group of users to an outsider, comprising embedding authenticated contact information of a member within the trusted group to a data communication composed by the outsider to a member of the trusted group. Authenticated contact information can be authenticated introductory information, used to indicate that the data communication of the outsider is considered to be desirable and trusted for the members of the group.

In an aspect, when the contact information is passed from a member to a trusted outsider, the contact information signifies that the communication is endorsed or authenticated by the member. The contact information can be the same contact information that the member uses in his communication to any other member, or can be the same contact information that the member uses in his communication to the specific member that the outsider desires to communicate. The contact information can be different, e.g., modified, for example, by a hashing algorithm between the member contact information and the identification of the outsider. The modification algorithm can be agreed upon between members, and is not public information. This can provide a more secure method of expanding the trusted group, since both the information regarding the modification algorithm and the contact information have to be compromised before a fraudulent data communication can be generated.

In an embodiment, an outsider composes a data communication addressed to a member of the trusted group, embedding introductory contact information given by another member or the same member of the trusted group. In an aspect, after receiving authenticated introductory contact information from the first member of the trusted group in order to communicate with a second member, an outsider composes a data communication addressed to the second member of the group, embedding the given contact information. The first and second members can be the same member, or can be different members.

The given introductory contact information can be the contact information of the first member, or the contact information of the first member used to communicate with the second member. The given introductory contact information can be the result of an algorithm using the member contact information as input. The algorithm also preferably uses some information from the outsider, such as the outsider email address or phone number, to perform identification checking. The introductory contact information can be authenticated contact information for the outsider, who will become member of the trusted group. Alternatively, new authenticated contact information for the outsider can be generated after the outsider becomes a member.

The contact information is disposable and may be changed at will so that if compromised, it can be changed and other members notified. The contact information can be encrypted, or can be periodically and automatically replaced to prevent exposure. For example, sent or received communication can include instruction on the replacement of the contact information of the sender, the receiver, or both, so that the contact information can essentially become one-time contact information, preventing fraudulent communication based on past communication.

In an embodiment, the contact information may be automatically generated, embedded and checked in the data communication without any user interaction. A database containing the contact information can be stored, with or without encryption, to be used for the automatic algorithm. Thus secured communication can be established for members of a trusted group, with provision for membership expanding; and all can happen in the background.

In an embodiment, the present invention discloses a data communication, for example, an email or a text message, to a member of a trusted group, comprising authenticated or introductory contact information, preferably disposable contact information, and more preferably, one time disposable contact information, from the same or different members of the same trusted group.

### BRIEF DESCRIPTION OF THE DRAWINGS

FIG. 1 illustrates an exemplary system, such as a computer or a mobile device system which may be used with the present invention.

FIG. 2 is a schematic block diagram of a sample network environment with which the present invention can interact.

FIG. 3 illustrates an exemplary message, e.g. an email or IM message.

FIGS. 4A-4C illustrate exemplary contact databases.

FIG. 5 illustrates an exemplary flow chart using authenticated contact information according to an embodiment of the present invention.

FIG. 6 illustrates an exemplary embodiment using one-time authenticated contact information.

FIG. 7 illustrates an exemplary embodiment where authenticated contact information or an authenticated contact key is automatic.

FIG. 8 illustrates an exemplary process for expanding the trusted group.

FIG. 9 illustrates an exemplary process for the recipient of a trusted communication.

FIG. 10 illustrates an exemplary process for receiving an authenticated message with an authenticated contact key.

### DETAILED DESCRIPTION OF THE PREFERRED EMBODIMENTS

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

In an embodiment, the present invention discloses methods and apparatuses for authenticating data communication, such as emessages. The present methodology can identify desired data communication, in addition or in place of filtering undesired messages. In as aspect, the present invention establishes a trusted group of users with a means to identify each other in communication, thus the communication between the members of the trusted group can be distinguished against unwanted messages. In an aspect, the present method comprises automatically generating and embedding authenticated contact information to the transmitted communication, thus providing security and ease of operation for the sender. In an embodiment, the present invention further provides methods and apparatuses to expand the trusted group, for example, to identify desired communication from outsiders.

The present invention provides a computer-readable recording medium on which a program and data are recorded and which when executed by a data processing system causes the system to perform various methods of the present invention, such as when a plurality of user devices and servers are interconnected over a network. The present invention may also be embodied in a machine or computer readable format, e.g., an appropriately programmed computer or a software program written in any of a variety of programming languages. The software program would be written to carry out various functional operations of the present invention. Moreover, a machine or computer readable format of the present invention may be embodied or stored in a variety of program storage devices, such as a diskette, a hard disk, a CD, a DVD, nonvolatile electronic memory, or the like. The software program may be run on a variety of devices, e.g. a processor.

Thus, a machine readable medium includes any mechanism that provides (i.e., stores and/or transmits) information in a form accessible by a machine (e.g., a computer, network device, personal digital assistant, manufacturing tool, any device with a set of one or more processors, etc.). For example, a machine readable medium includes recordable/non-recordable media (e.g., read only memory (ROM), random access memory (RAM), magnetic disk storage media, optical storage media, flash memory devices, etc.), as well as electrical, optical, acoustical or other forms of propagated signals (e.g., carrier waves, infrared signals, digital signals, etc.), etc.

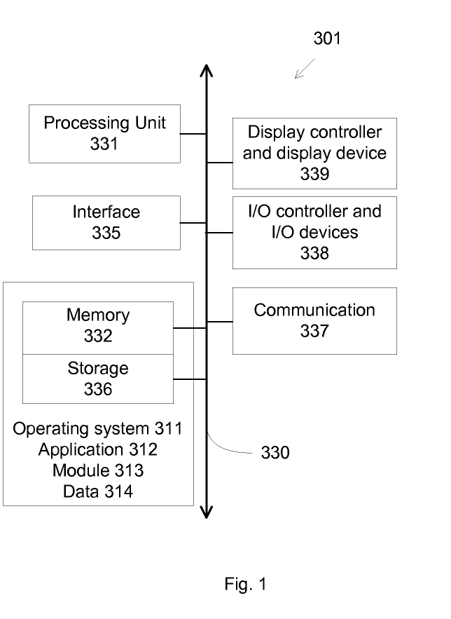

FIG. 1 illustrates an exemplary system, such as a computer or a mobile device system 301 which may be used with the present invention. Note that while FIG. 1 illustrates various components of a computer system, it is not intended to represent any particular architecture or manner of interconnecting the components as such details are not germane to the present invention. It will also be appreciated that network computers and other data processing systems which have fewer or more components may also be used with the present invention. The system of FIG. 1 may, for example, be a mobile device, a cell phone, a PDA, or a computer or server. The system 301 comprises a processing unit 331, a system memory 332, and a system bus 330. The processing unit 331 can be any of various available processors, such as single microprocessor, dual microprocessors or other multiprocessor architectures. The system bus 330 can be any type of bus structures or architectures. The system memory 332 can include volatile memory and nonvolatile memory. System 301 also includes storage media 336, such as removable/nonremovable, volatile/nonvolatile disk storage, such as magnetic disk drive, optical disk drive, or memory drive. A removable or non-removable interface 335 can be used to facilitate connection.

It will be apparent from this description that aspects of the present invention may be embodied, at least in part, in software. That is, the techniques may be carried out in a system or other data processing system in response to its processor, such as a microprocessor, executing sequences of instructions contained in a memory or a remote storage device. In various embodiments, hardwired circuitry may be used in combination with software instructions to implement the present invention. Thus, the techniques are not limited to any specific combination of hardware circuitry and software or to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor.

The system 301 further can include software to operate in a network environment, such as an operating system 311, system applications 312, program modules 313 and program data 314, which are stored either in system memory 332 or on disk storage 336. Various operating systems or combinations of operating systems can be used. I/O controller and I/O devices 338 can be used to enter commands or data, and can include but is not limited to, a keyboard, a phone keypad, or a pointing device, preferably connected through I/O controller interface ports. Display devices and display controller 339 such as video or sound cards are provided to connect to some external output devices such as monitors, speakers, and printers.

System 301 can operate in a networked environment with other remote devices, which typically includes many or all of the elements described relative to device 301. Remote devices can be connected to device 301 through a communication 337.

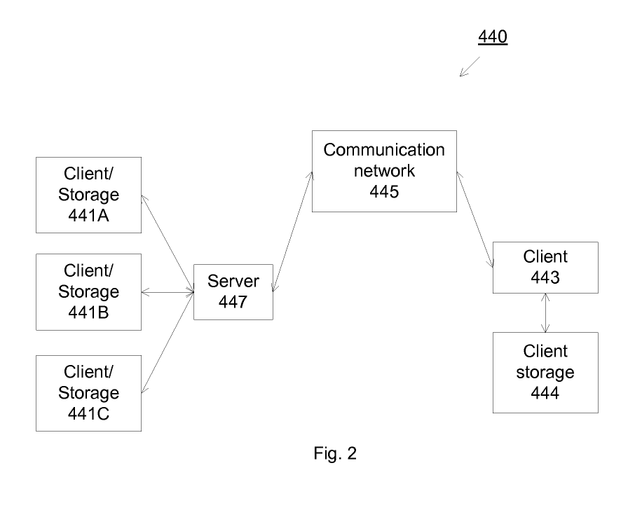

FIG. 2 is a schematic block diagram of a sample network environment 440 with which the present invention can interact for exchanging a variety of electronic communication including emessages such as email messages and phone messages. The network environment 440 includes a plurality of client systems/storage 443/444 and a plurality of servers (web server, email server or phone switch) 447 connected to a plurality of client/storage units 441A-441C. The clients 441A-C, the server 447, and the client 443 can be used to employ the present invention. The environment 440 includes a global multi-way communication network 445, such as the Internet, a phone network, to facilitate communications between the clients 441A-C and 443. The clients 441A-C can be in a local network connected to the server 447, which can manage the communication of the clients 441A-C to the outside.

In an embodiment, the present invention addresses the requirement of spam prevention by providing improved systems, processes, and computer algorithms for filtering and receiving trusted messages from a stream of emails. The mechanism of the present invention employs a trusted group, with provision for expansion. Each member of this trusted group shares an authenticating algorithm and maintains a trusted contact information database.

Communication software, such as an email package, can reside in the client 443, or in the server 447, which handle email for clients 441A-C. For example, client 443 can compose an email or IM and send to client 441A through the communication network 445. The authentication process can happen automatically at the software package level, embedding authenticated information to the email before sending out. Server 447 receives the email, and sends it to client 441A. Email authentication or filtering can happen at the server 447 and/or the client 441A. When composing an electronic message, authenticated contact information can be automatically embedded. From the sender's perspective, the message is simply composed and sent.

The mail or IM server receives a stream of emails, phone messages or IMs addressed to the users of the server, which can be undesired spam or desired messages. The authentication algorithm attempts to deliver the desired messages to the users while blocking, marking or quarantining the non-authenticated and hence questionable emessage such as spam or crank phone calls. An authenticated contact information list may be used to check if the sender of the message has already been explicitly identified as a creator of desired messages. If the sender is on the trusted list, the message is considered desired and transmitted to the user. If the sender is not on the trusted list, the message is not considered to be trusted, and diverted by the invention for further processing. The authentication process may have multiple levels of filtering techniques, for example, rejected messages might undergo additional filters.

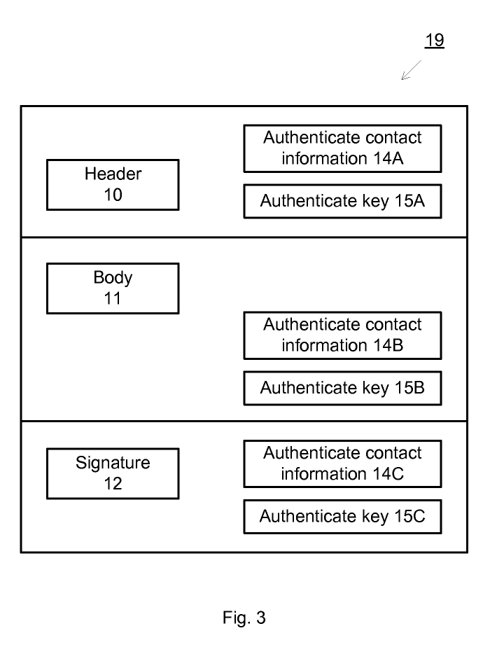

FIG. 3 illustrates an exemplary message 19, comprising a header 10, a body 11, and a signature portion 12. Other portions of the message can also be included. The body 11 and the signature portion 12 can be omitted. The header 10 typically comprises a sender identification (such as an email address or phone number of the sender), a receiver identification (such as an email address or phone number of the receiver), and a subject line. Other portion, such as cc or bcc can be included.

Included in the message is authenticated contact information 14A, 14B, or 14C, identifying that the message is from a member of the trusted group. FIG. 3 illustrates multiple occurrences of authenticated contact information 14A-14C to show the possible locations of authenticated contact information, but in practice, a single occurrence of authenticated contact information is adequate. Authenticated contact information can be located in the header 14A, in the body 14B, or in the signature portion 14C. For example, authenticated contact information 14A can be embedded in the sender information or receiver information, such as replacing or adding to the email address or phone number of the sender or receiver. Authenticated contact information can be in the subject heading, or in any other portions. Authenticated contact information can be hidden, e.g., not shown when view. In an aspect, the location of authenticated contact information is fixed to simplify the authentication process. In an aspect, authenticated contact information can be positioned anywhere in the message to facilitate the sending algorithm, and to prevent fraud. In this case, the authentication process can search throughout the message to locate authenticated contact information.

Authenticated contact information can be any type of string, such as an alphanumeric string, string of any characters, or even binary string. Authenticated contact information can be encrypted, for example, with an authentication key.

The message can contain an authenticated key with FIG. 3 showing the possible locations of an authenticated key 15A-15C. An authenticated key can be hidden. Typically, only one authenticated key is adequate. An authenticated key is optional, for example, needed only when a change of authenticated contact information is desired. An authenticated key can be sent in every message, effectively creating a one-time occurrence of authenticated contact information, since the next authenticated contact information will be changed based on the current authenticated key.

After receiving a message, for example, by a message server or by the client, the message is checked for authenticated contact information. For example, authenticated contact information can be retrieved from the message, and then checked against a contact database. Alternatively, authenticated contact information in the contact data base is checked against the message, to see if the message contains the correct authenticated contact information. For example, sender identification, such as an email address or phone number, can be retrieved first. The sender identification can be checked by a software method such as contact database, hash table or a cryptographic signature to retrieve contact information. This contact information is then checked against the message to see if the message contains the contact information.

Authenticated contact information can be authenticated contact information, or can be a function of authenticated contact information. For example, authenticated contact information can be generated from an algorithm using authenticated contact information or a hashing process with authenticated contact information and some other information (such as the sender email address or phone number) can generate authenticated contact information.

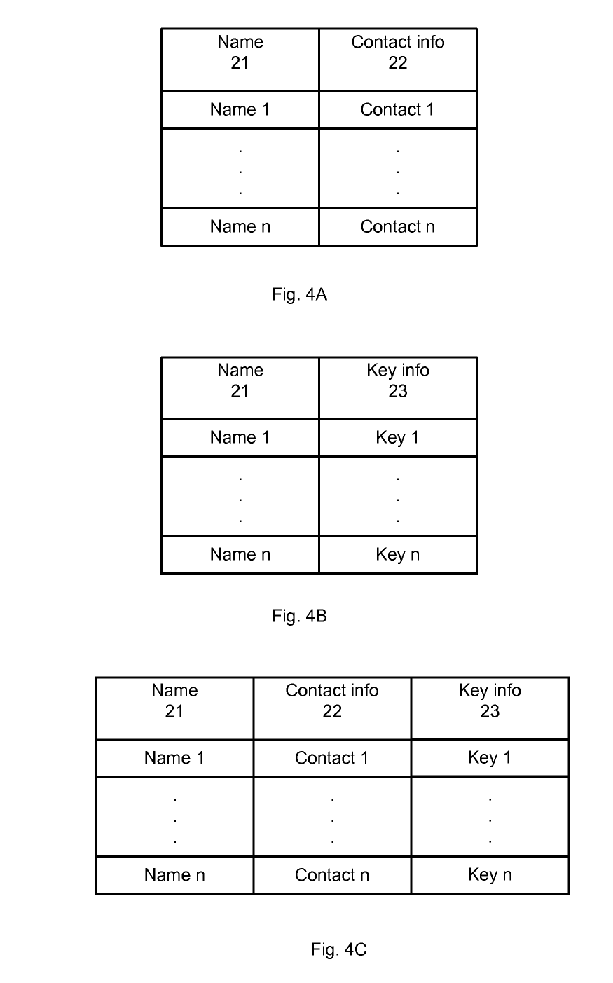

FIG. 4A illustrates an exemplary contact database, comprising a name list 21 and a contact information list 22. The name list 21 includes a list of names, such as name 1, name 2, etc. The names are linked to the contact information list 22, for example, name 1 has contact 1, etc. The contact information can be authenticated contact information. FIG. 4B illustrates another exemplary contact database, comprising a name list 21 and a key information list 23. An algorithm using the name and the key within this list can generate authenticated contact information. The algorithm can use additional information to generate authenticated contact information. FIG. 4C illustrates another exemplary contact database, comprising a name list 21, a contact information list 22, and a key information list 23. The contact information list or the key information list can provide authenticated contact information for the name list. The key information list might contain the key needed to generate the next authenticated contact information, for example, for a one-time authenticated contact information feature.

In some embodiments, the present invention provides an anti-spam system that can be used to block spam from reaching a user. The present system does not rely on rules to identify spam. Instead the system identifies particular data communication as trusted communication based on authenticated contact information. The communication that has authenticated contact information is considered desirable and delivered to the intended recipient. In an aspect, messages without authenticated contact information are subjected to other rules for spam determination. Authenticated contact information can be pre-arranged information between two users or between members of a trusted group. Authenticated contact information is disposable information. Thus, if it is compromised, the other user or the entire trusted group is notified, and authenticated contact information may be changed.

In an aspect, a user has a permanent address for messages, such as an email address or a phone number, together with authenticated contact information to reduce the number of unsolicited bulk messages, e.g. spam, unwanted phone calls. Authenticated contact information can be encrypted or not encrypted. Further, authenticated contact information can be a key to generate another occurrence of authenticated contact information to be sent.

Thus, in some embodiments, the present method adds disposable contact information to be used in conjunction with the permanent address. This method also allows secondary parties for which trusted (and desired) contacts are established to allow third parties to safely receive contact information allowing the primary recipient to easily block parties without the need for complex rules on communication and without the need for complex and CPU intensive heuristics performed on received data.

Initially, when a permanent address is created, it is generally shared privately between two parties who exchange contact information. After that point, additional contacts are frequently added through social networking between contacts of contacts. For example, a business contact forwards an email address and phone number to another business contact, or a brother gives out the contact information to a cousin.

By using tags that are unique between the sender and the receiver, tags can allow users to identify patterns of abuse when their contact information is passed out by a contact that was considered trusted. The receiver of a block of data from a previously unknown contact in email, instant messages, etc., can determine how contact information was passed out, and allow blocking based on this tag.

In an aspect, the present invention allows establishing a tag which will identify not only the sender of a block of data, but can also identify the receiver of a block of data and allow sorting based solely on this tag. If the tag is unknown, the recipient can simply discard the received data with a high degree of confidence that the sender of the data has no knowledge of who the recipient is, which is the general case of unwanted and unsolicited mass marketing but not the case for trusted contacts for which communication is desired.

The tag can identify the user when communicating with all other users. Alternatively, a tag can identify a communication between two users, or a recommendation from a third user. For example, if A and B have established communication through conventional means, and A can establish the use of tag T^{ab} every time they communicate with B, and B can establish use of tag T^{ba} to communicate with A, there now exists secondary field to establish that any message received by A with tag T was received by a somewhat trusted 3^{rd} party if the sender isn't actually sender B. If a previously unknown contact C uses tag T^{ba} to send data to A, A can identify that B is the original source for giving out contact information to C so C is able to communicate with A with a high degree of confidence that A will know that the received message is not unsolicited.

Hashing algorithms can be used to further enhance the probability that tag T^{ba} won't be abused by the 3 party. For example, if B wants to give C contact information such that C can communicate with A, B can give C a hashed version of tag T^{ba}. Such a hashing algorithm could be a function such that:

T=hash (Address of C, T^{ba})

Hashing would be a one way function, that is, given T, it is impossible to determine with certainty what T^{ba} is. The particular hashing algorithm could include, but would not be limited to, md5 sums, shal sums, DES encryption using a hashed version of Address of C for the encryption key, etc. Any method can be used so long as both software clients understand the method. New methods can be added and capabilities announced between clients.

Hashing algorithms exist such that there is very little chance of two tags being created that are the same given different input. These algorithms are considered cryptographically secure with today's technology and would be preferable for use. There is no limitation surrounding the hashing algorithm used as long as both sender and receiver understand the hashing algorithm and the hashing algorithm are specified. Supported algorithms by users can be advertised within any message by supported software clients without user intervention, and optionally, users can elect to disable support of particular algorithms. Algorithms can be, but are not limited to, hashing algorithms, database lookups, etc.

When recipient A receives a message with this previously unseen tag encoded in it, A can go through all it's known and valid tags, hash them with the permanent address of C and identify that not only is the previously unseen tag valid and created by a person for which they already have previously established communication, but it was contact B that gave C A's contact information. Using this method, it's easy to identify patterns of abuse in sharing contact information. This can also be automated so that when a user introduces C to A, that the newly formed hashed tag is automatically generated by the program being used.

Tags can be of arbitrary length, but to give an example of the strength of using such a tag, the alphabet alone contains 26 characters, and a tag of only 4 characters would yield a possible 26⁴ combinations, or about ½ million possible combinations. If character case were also taken into account, that would be 52⁴, or 7 million combinations. Using 8 characters would give a possible number of 53 billion, making the probability of, for example, an email marketer being able to guess a valid tag astronomically small. Including numeric characters, symbols, etc., will further reduce the likelihood that a malicious email sender can guess a valid tag.

Tags need not be unique between two parties. For example, if person with address A signs up to an email or IM list called L, A can just add the tag that L uses to A's list of valid tags. Should A receive a junk email or IM based on a hashed tag from L, A can simply setup a rule to ignore all subsequent emails or IMs based off hashed values of L or place received emails or IMs into a quarantined folder. User A may also elect to have any message received by 3^{rd} parties using L's tag to be quarantined or discarded,

When new authenticated contact information is generated, the user informs the other member of the trusted group of the new authenticated contact information. The change of the user's authenticated contact information can be communicated to directories or other sources of email addresses by any suitable means. The service provider, ISP, registrar or hosting company may offer a range of options to the user in this regard. Alternatively, the user may have a customized service according to his or her particular needs and habits. For instance, when the user's authenticated contact information is changed, the service provider, ISP, registrar or hosting service operating the address-generating message server can inform a directory of the user's new authenticated contact information. An algorithm in the receiver server or computer can receive the new authenticated contact information and update the database.

Suppose a user C, for example, has their computer compromised by a virus or a thief. In this event, all the valid tags that C uses to communicate with C's trusted parties are compromised. In this event, all of C's trusted contacts can invalidate the tags used to communicate with C and give C new tags to use to communicate with them. Alternatively, C can simply invalidate his own tags, and request new ones with his contacts. This is a common problem today with unsolicited email marketing; a virus will infiltrate a computer, and will use all message addresses it finds to send unsolicited messages using a forged sending address (e.g. email address or phone number). Using tags allows other parties to identify C as the party that, knowingly or unknowingly, forwarded their contact information to unwanted third parties. Action can be taken, such as running a virus scan on the computer, or removing C from trusted contact lists. Moreover, since the information is in a tree form, a party can remove from their trusted list any parties they contacted via C.

Invalidation of tags on demand is also possible and can be automated by the client program(s). Tags can also be given a limited lifespan or be invalidated or updated upon request by any user to another. In the event a user is signed up to a mailing list, having the mailing list continually change the tag and alert recipients who are signed up on such a mailing list will reduce the possibility that a malicious user can send unwanted email. Mailing lists today are generally tightly controlled, and users who abuse the mailing list are regularly banned.

Multiple tags can be established between two parties such that one tag is considered entirely secret between two parties and another tag is used when giving contact information to 3rd parties. This would eliminate any need for a hashing algorithm and provide the same or superior level of security. Two trusted contacts may establish multiple additional tags for the purpose of using the non-primary tag for sharing with 3rd parties. In the event that A and B have previously established communications, it is possible for B to indicate to A that a new tag has been created by B so that C may communicate with A by spontaneously creating this new tag and providing it to both C and A thereby guaranteeing that C and A can communicate with one another. Client software can handle this silently without the need for A (the recipient) to do anything. Tags may uniquely identify an individual, but having the tag of a user does not necessarily allow contact between two parties, since the permanent contact information may remain unknown—therefore, it is safe to give out tags freely to all known contacts all the time, silently—even to untrusted 3rd parties from whom communication is not desired.

Currently, no mechanism exists in any communication medium to allow people who would normally want to communicate with one another to communicate with one another with a high degree of confidence that the received message should be received and is from somebody that would have knowledge of who they are communicating with. Only this method gives a high degree of confidence that the sender and receiver have some knowledge of the identification of each.

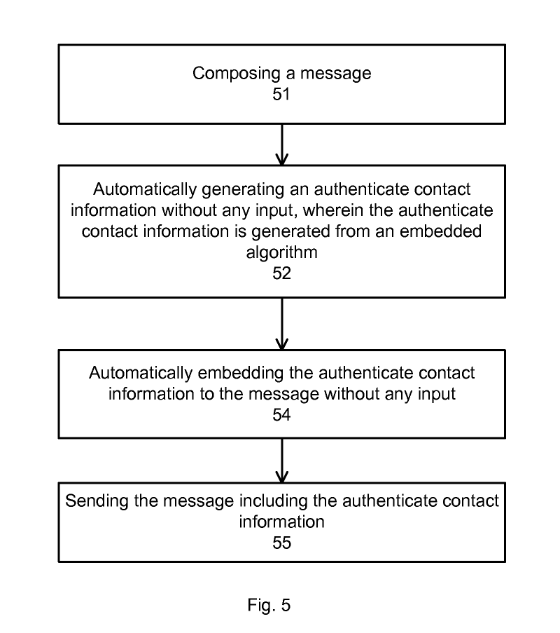

FIG. 5 illustrates an exemplary flow chart according to an embodiment of the present invention. Operation 51 provides that a user composes a message or a data communication. The message can contain the user identification, such as the user email address. Operation 52 is optional, which generates authenticated contact information before operation 54 embeds authenticated contact information in the message. Authenticated contact information can be generated or pulled from a database automatically without any input from the user, wherein authenticated contact information is generated from an embedded algorithm, such as an algorithm residing in the email software. Authenticated contact information can be retrieved from a look up table containing the contact information. In an aspect, the user can enter authenticated contact information, for example, by adding it to the signature portion of the message. In an aspect, authenticated contact information is automatically embedded in the message without any input. For example, email or IM software can use a look up table and pre-arranged algorithm, using input as the user identification, and optionally the recipient identification. In operation 55, the message is sent to the recipient, including the embedded authenticated contact information.

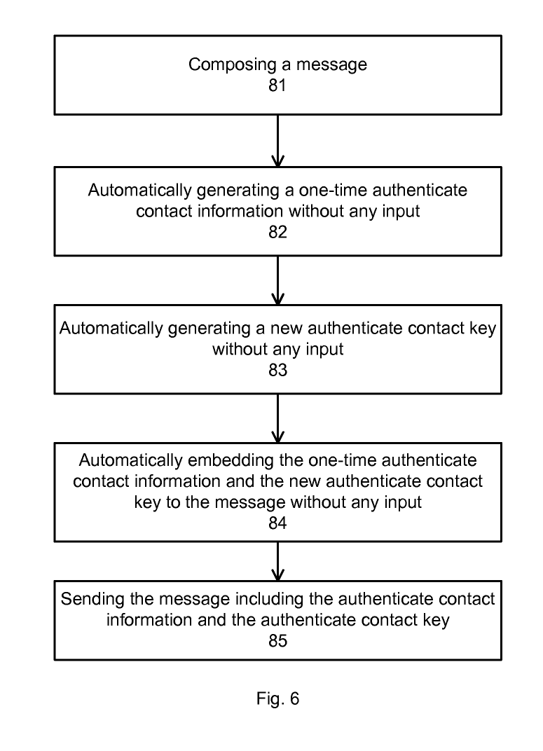

FIG. 6 illustrates an exemplary embodiment using one-time authenticated contact information. Operation 81 composes a message. Operation 82 generates authenticated contact information, preferably automatically without any input. For example, authenticated contact information can be generated from an algorithm utilizing an authenticated contact key stored in the email software. Operation 83 generates a new authenticated contact key, preferably automatically without any input. The new authenticated contact key can replace the existing authenticated contact key, and can be used to generate authenticated contact information in future messages. Operation 84 embeds authenticated contact information and an authenticated contact key to the message, preferably automatically without any input. Operation 85 sends the message to the recipient, including authenticated contact information and an authenticated contact key.

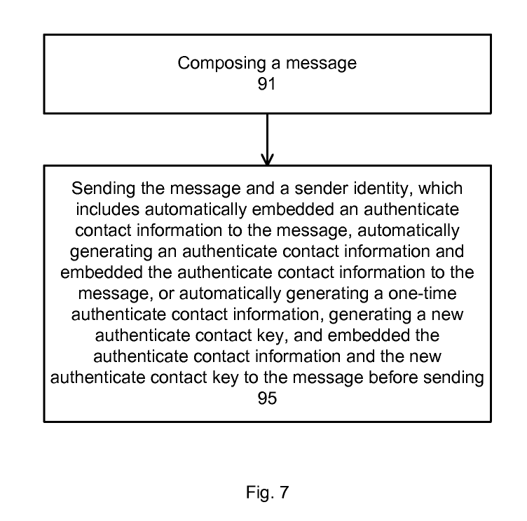

FIG. 7 illustrates an exemplary embodiment where the process of automatically generating and embedding authenticated contact information or an authenticated contact key can be triggered any time during the message process, such as when the message is sent, when the sender presses the send button to send the message, or when the message software is started. Operation 91 composes a message. Operation 95 sends the message and a sender identity, with authenticated contact information and/or an authenticated contact key is derived (e.g. generated or retrieved from a database) and embedded in the message.

In an embodiment, authenticated contact information is generated and linked to a user's permanent email address by an algorithm in the user computer. The algorithm can be programmed to generate new authenticated contact information on an ongoing basis at intervals based on prescribed criteria. The criteria may be time based (e.g., changed every 30 days) or volume based (e.g., changed after each new message received). Alternatively, authenticated contact information may be changed on demand of the email user or other person.

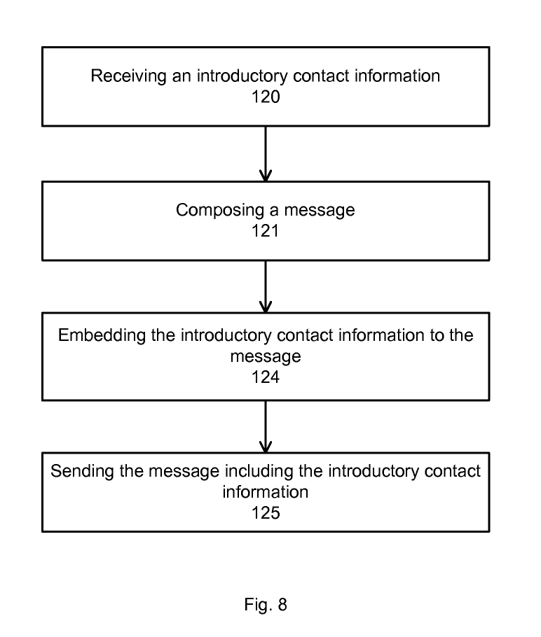

FIG. 8 illustrates an exemplary process for expanding the trusted group, by providing an invitation in the form of introductory contact information to an outsider. Operation 120 provides that the outsider receives introductory contact information from a member of a trusted group. The introductory contact information can also be specific as to the recipient of the introductory contact. The introductory contact information can be authenticated contact information of the recommending member, or a function of the member's authenticated contact information. For example, the introductory contact information can be a hashing function of authenticated contact information and the email address of the outsider. The outsider then composes a message, in operation 121, and embeds the introductory contact information to the message in operation 124. The embedding process can be performed manually by the outsider, or can be performed automatically by the email software. For example, the outsider might have email or IM software that automatically embedded authenticated contact information, and thus the outsider can input the introductory contact information to a contact database, where the software will look to generate and embed the contact information to the message. Operation 125 sends the message to the intended recipient, including the introductory contact information.

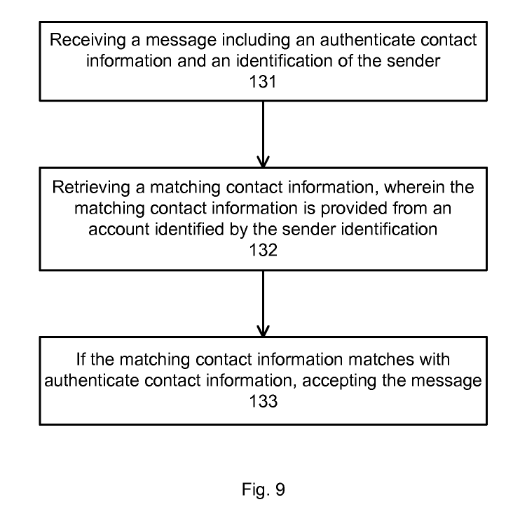

FIG. 9 illustrates an exemplary process for the recipient of a trusted communication. Operation 131 provides that a message is received, including authenticated contact information and an identification of the sender, such as the sender's message address (e.g. email address or phone number). The message can be received by the message server or the computer system or phone of the recipient. Authenticated contact information can be regular authenticated contact information from a member of a trusted group to another member, or introductory contact information from an outsider. In an aspect, before accepting the message, the system software performs checking to determine whether or not the message is desirable, for example, from a trusted group. For example, if the message is received without authenticated contact information, the system (e.g., the software running the email or IM program) can decide that this message is not from a trusted group, and thus can reject the message, store the message to a suspect list, or pass it to a second spam filter program. In operation 132, the system checks to see if authenticated contact information is valid, for example, by retrieving matching contact information from a contact database, or from a verification algorithm having input from a contact database. The supplied information from the contact database can be retrieved from an account or entry identified by the sender information. The matching contact information can be generated from a verification algorithm, utilizing stored information (such as contact key), and received information from the message (such as the sender identification). In operation 133, the message is accepted and delivered to the recipient if the matching contact information matches with the received authenticated contact information. This signifies that the sender is within, or potentially recently added to, the trusted group, and the message is desirable. If the information does not match, then the message can be rejected, stored to a suspect list, or passed to a second spam filter program. The verification of communication can be performed manually, or preferably performed automatically. One major advantage of the present trusted group verification is that trusted messages are always delivered without failure, and the user does not have to be concerned with a faulty spam filter and does not have to check the spam mailbox to see if there is any desired message has been mistakenly identified as spam.

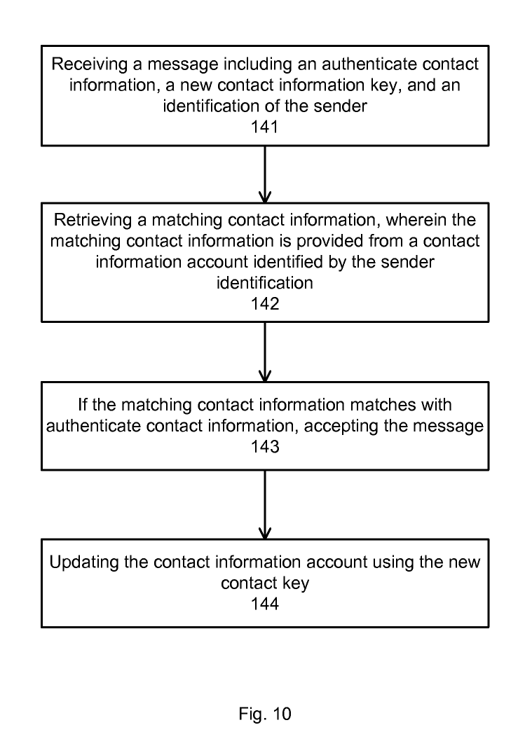

FIG. 10 illustrates an exemplary process for receiving an authenticated message with an authenticated contact key for updating the encryption of authenticated contact information. In operation 141, a message is received including authenticated contact information, a new contact information key, and an identification of the sender. In operation 142, the system, such as the email software running on an email server, which communicates with the network and which receives the message, retrieves matching contact information, wherein the matching contact information is provided from a contact information account identified by the sender identification. Other methods to retrieve matching contact information can be used, such as the methods used in previous sections. In operation 143, if the matching contact information matches with authenticated contact information, the message is accepted, and delivered to the intended recipient. In operation 144, the system updates the contact information account with the new contact key. In an embodiment, this process can be used for introductory contact information, utilizing authenticated contact information of the member who introduces the outsider to the trusted group. The new contact key can be a contact key or authenticated contact information for the outsider who will be a new member of the trusted group, and will need to establish his own account information.

The present invention can be a new application, or can be applied to existing software without significant modification. Email, Instant Message, phone, etc. clients that do not support the use of tags do not need to be upgraded to receive messages from clients that do support the use of tags. Existing infrastructure does not need to be replaced for this invention to be used. The present invention also can be used in conjunction with existing anti-spam methodology and processes.

Existing anti-spam method includes using passwords. Others include simple whitelists where the claimed sender of a message is checked against a list of authorized senders. Bayesian filtering also exists. This method inspects incoming messages for keywords which have been marked by the receiver as likely to be unwanted and unsolicited email. This method may need training by the user that makes use of and requires constant maintenance. Another example of existing anti-spam art is making use of disposable message addresses, or using a challenge/response mechanism. Another existing art is to simply establish that the claimed sender of a message actually is a valid email address.

Although the present invention has been described with reference to specific exemplary embodiments, it will be evident that the various modification and changes can be made to these embodiments without departing from the broader spirit of the invention as set forth in the claims. For example, the communication message can take any of a variety of forms, such as using email protocols, such as SMTP, such as web-based protocols, such as HTTP and SOAP, such as wireless protocols for hand-held devices, such as IM protocols, such as P2P protocols, such as phone SMS protocols, or any other protocols suitable for electronic messages. The message also may take the form of an SMTP conversation, a separate email message, an independent phone call, a form request submitted over the web, etc. The message can encompass a wide range of electronic communication types. Accordingly, the specification and drawings are to be regarded in an illustrative sense rather than in a restrictive sense.

What is claimed is:

1. A method for communication, comprising
composing an electronic communication, the electronic communication comprising sender identification, wherein the sender identification is permanent information;
embedding authenticated contact information to the electronic communication, wherein authenticated contact information is disposable information; and
sending the electronic communication to a recipient,
wherein authenticated contact information authenticates the sender to the recipient.

2. The method of claim 1 wherein the electronic communication comprises an electronic message.

3. The method of claim 1 wherein authenticated contact information is unique between the sender and the recipient.

4. The method of claim 1 wherein authenticated contact information comprises at least one of the sender identification and the recipient identification, which are retrievable by a software algorithm.

5. The method of claim 1 wherein authenticated contact information comprises a hash calculated based on at least one of the sender identification and the recipient identification.

6. The method of claim 1 wherein authenticated contact information is retrieved or generated from a contact database.

7. The method of claim 1 wherein authenticated contact information is automatically embedded in the electronic communication.

8. The method of claim 1 wherein authenticated contact information is automatically and periodically replaced through a pre-arranged algorithm.

9. The method of claim 1 wherein authenticated contact information is a one-time authenticated contact information.

10. The method of claim 1 further comprising
embedding new authenticated contact information to the electronic communication, new authenticated contact information is to replace current authenticated contact information.

11. The method of claim 1 further comprising
embedding a contact key to the electronic communication, the contact key establishing new authenticated contact information.

12. The method of claim 1 wherein authenticated contact information is introductory information received from a user.

13. The method of claim 12 wherein authenticated contact information comprises an identification of the user which is retrievable by a software algorithm.

14. The method of claim 12 wherein authenticated contact information comprises a hash calculated based on an identification of the user.

15. The method of claim 12 wherein authenticated contact information comprises an identification of the user and the sender identification, which are retrievable by a software algorithm.

16. The method of claim 12 wherein authenticated contact information comprises a hash calculated based on an identification of the user and the sender identification.

17. A method for communication, comprising
receiving an electronic communication from a sender;
extracting a sender identification and authenticated contact information from the electronic communication;
checking authenticated contact information to match with the sender identification; and
accepting the electronic communication if matched,
wherein authenticated contact information authenticates the sender.

18. The method of claim 17 further comprising
rejecting the electronic communication if not matched.

19. The method of claim 17 further comprising
subjecting the electronic communication to a spam filter if not matched.

20. The method of claim 17 wherein checking authenticated contact information comprises
retrieving sending contact information from authenticated contact information;
retrieving stored contact information from an account identified by the sender identification; and
matching the sending contact information with the stored contact information.

21. The method of claim 17 wherein checking authenticated contact information comprises
retrieving sending contact information from authenticated contact information; and
matching the sending contact information with the sender identification.

22. The method of claim 17 wherein checking authenticated contact information comprises
retrieving sending contact information from authenticated contact information; and
matching the sending contact information with contact information in the contact database.

23. A recordable-type medium having stored thereon a sequence of instructions which when executed by a computer, cause the computer to perform a method comprising:
composing an electronic communication, the electronic communication comprising sender identification, wherein the sender identification is permanent information;
embedding authenticated contact information to the electronic communication, wherein authenticated contact information is disposable information; and
sending the electronic communication to a recipient,
wherein authenticated contact information authenticates the sender to the recipient.

24. The medium of claim 23 wherein authenticated contact information comprises a hash calculated based on at least one of the sender identification and the recipient identification.

25. The medium of claim 23 wherein authenticated contact information is automatically and periodically replaced through a pre-arranged algorithm.

26. The medium of claim 23 wherein authenticated contact information is a one-time authenticated contact information.

27. The medium of claim 23 further comprising
embedding new authenticated contact information to the electronic communication, new authenticated contact information is to replace current authenticated contact information.

28. The medium of claim 23 further comprising
embedding a contact key to the electronic communication, the contact key establishing new authenticated contact information.

29. A recordable-type medium having stored thereon a sequence of instructions which when executed by a computer, cause the computer to perform a method comprising:
receiving an electronic communication from a sender;
extracting a sender identification and authenticated contact information from the electronic communication;
checking authenticated contact information to match with the sender identification; and
accepting the electronic communication if matched,
wherein authenticated contact information authenticates the sender.

30. The medium of claim 29 wherein checking authenticated contact information comprises
retrieving sending contact information from authenticated contact information;
retrieving stored contact information from an account identified by the sender identification; and
matching the sending contact information with the stored contact information.

31. The medium of claim 29 wherein checking authenticated contact information comprises
retrieving sending contact information from authenticated contact information; and
matching the sending contact information with the sender identification.

32. A data processing system for managing electronic communication, the data processing system comprising:
a processor; and
a memory coupled to the processor, the memory storing instructions which when executed by the processor cause the processor to perform a method, comprising:
composing an electronic communication, the electronic communication comprising sender identification, wherein the sender identification is permanent information;
embedding authenticated contact information to the electronic communication, wherein authenticated contact information is disposable information; and
sending the electronic communication to a recipient,
wherein authenticated contact information authenticates the sender to the recipient.

33. The data processing system of claim 32 wherein authenticated contact information comprises a hash calculated based on at least one of the sender identification and the recipient identification.

34. The data processing system of claim 32 wherein authenticated contact information is automatically and periodically replaced through a pre-arranged algorithm.

35. The data processing system of claim 32 wherein authenticated contact information is a one-time authenticated contact information.

36. The data processing system of claim 32 further comprising
embedding new authenticated contact information to the electronic communication, new authenticated contact information is to replace current authenticated contact information.

37. The data processing system of claim 32 further comprising
embedding a contact key to the electronic communication, the contact key establishing new authenticated contact information.

38. A data processing system for managing electronic communication, the data processing system comprising:
a processor; and
a memory coupled to the processor, the memory storing instructions which when executed by the processor cause the processor to perform a method, comprising:
receiving an electronic communication from a sender;
extracting a sender identification and authenticated contact information from the electronic communication;
checking authenticated contact information to match with the sender identification; and
accepting the electronic communication if matched,
wherein authenticated contact information authenticates the sender.

39. The data processing system of claim 37 wherein checking authenticated contact information comprises
retrieving sending contact information from authenticated contact information;
retrieving stored contact information from an account identified by the sender identification; and
matching the sending contact information with the stored contact information.

40. The data processing system of claim 37 wherein checking authenticated contact information comprises
retrieving sending contact information from authenticated contact information; and
matching the sending contact information with the sender identification.
